(19) United States
(12) Patent Application Publication
(10) Pub. No.: US 2017/0178518 A1
(43) Pub. Date: Jun. 22, 2017

(54) METHOD AND APPARATUS FOR CONTROLLING AN AERIAL DRONE THROUGH POLICY DRIVEN CONTROL RULES

(71) Applicant: AT&T Intellectual Property I, L.P., Atlanta, GA (US)

(72) Inventors: Mark Jeffrey Foladare, East Brunswick, NJ (US); Robert M. Higgins, Manasquan, NJ (US); Reuben Klein, East Brunswick, NJ (US)

(21) Appl. No.: 14/971,701

(22) Filed: Dec. 16, 2015

(51) Int. Cl. G08G 5/00; B64C 39/02

(52) U.S. Cl. CPC G08G 5/0034; B64C 39/024; G08G 5/0039; G08G 5/006; G08G 5/0069; B64C 2201/146

(57) ABSTRACT

Examples for controlling an aerial device are described. An example method includes a processor receiving a request comprising an origin location and a destination location, determining a flight path based on the origin location and the destination location, wherein the flight path is determined based on at least one policy driven control rule, providing the flight path in response to the request and monitoring an unmanned aerial vehicle traversing the flight path.

The present disclosure relates generally to methods, computer readable media and apparatuses for controlling at least one aerial drone through policy driven control rules via a network, e.g., a communications network, an access network, or a virtualized network.

### BACKGROUND

Aerial drones are widely available, where radio signals are often used to control the flight of these aerial drones. However, controlling an aerial drone is often limited by the range of the radio signal or is limited to within sight of the user controlling the aerial drone. Additionally, regulations relating to how airspaces are to be used vary greatly from location to location. Such limitations present a challenge to the use of aerial drones in a commercial application, e.g., delivery of packages, and the like.

### SUMMARY

Examples of the present disclosure disclose methods, computer-readable media and apparatuses for controlling an aerial device. An example method includes a processor for receiving a request comprising an origin location and a destination location, determining a flight path based on the origin location and the destination location, wherein the flight path is determined based on at least one policy driven control rule, providing the flight path in response to the request and monitoring an unmanned aerial vehicle traversing the flight path.

In another example, a computer-readable medium stores instructions that, when executed, cause a processor to perform operations that include receiving a request comprising an origin location and a destination location, determining a flight path based on the origin location and the destination location, wherein the flight path is determined based on at least one policy driven control rule, providing the flight path in response to the request and monitoring an unmanned aerial vehicle traversing the flight path.

### BRIEF DESCRIPTION OF THE DRAWINGS

FIG. 1 illustrates an example network related to the present disclosure;

FIG. 2 illustrates an example physical environment in which an unmanned aerial vehicle, e.g., an aerial drone may traverse;

FIG. 3 illustrates an example volumetric environment in which an unmanned aerial vehicle, e.g., an aerial drone can be controlled;

FIG. 4 illustrates a flowchart of an example method for controlling an unmanned aerial vehicle, e.g., an aerial drone through policy driven control rules via a network according to the present disclosure;

FIG. 5 illustrates a flowchart of another example method for controlling an unmanned aerial vehicle, e.g., an aerial drone through policy driven control rules via a network according to the present disclosure; and

FIG. 6 illustrates an example high-level block diagram of a computing device for performing the functions, methods, operations and algorithms described herein.

To facilitate understanding, identical reference numerals have been used, where possible, to designate identical elements that are common to the figures.

### DETAILED DESCRIPTION

The present disclosure provides methods, computer readable media and apparatuses for controlling an unmanned aerial vehicle, e.g., an aerial drone, through policy driven control rules via a network, e.g., a communications network, an access network, or a virtualized network. As discussed above, aerial drones, an example of an unmanned aerial vehicle, are widely available, where radio signals are often used to control the flight of these aerial drones. Unfortunately, controlling an aerial drone is often limited by the range of the radio signal or is limited to within sight of the user controlling the aerial drone. Additionally, regulations relating to how airspaces are to be used vary greatly from location to location. Thus, such limitations present a challenge to the use of aerial drones in a commercial application, e.g., delivery of packages, and the like. In other words, scaling is a problem if policy enforcement is reliant exclusively on human behavior for each and every aerial drone that is deployed.

Furthermore, the use of aerial drones in a commercial setting where the aerial drones will traverse great distances are problematic in terms of meeting many stringent flight regulations. An operator of the aerial drones must comply with these stringent flight regulations that are designed to enforce security measures and safety concerns. Given that security measures may be dynamically implemented or modified, the operator of these aerial drones must continually understand and follow new flight regulations. Failure to comply with these stringent flight regulations will bring about significant fines or penalties that will again present a significant barrier to the use of aerial drones in a commercial application. Said another way, the degrees of freedom as to a zone of operation for an aerial unmanned vehicle are significant when compared to a land based vehicle, e.g., a car, which is often limited to roadways that are very well defined, e.g., having two degrees of freedoms versus three degrees of freedom for aerial flights. Such degrees of freedom in the zone of operation, e.g., a flight path, having all three degrees of freedom, e.g., longitude, latitude and altitude, create a challenge for the operation of an aerial unmanned vehicle. Additional operating parameters include speed, acceleration and heading, e.g., a direction of travel.

In one example, the present disclosure provides methods, computer readable media and apparatuses for controlling an aerial drone through policy driven control rules via a network, e.g., a communications network, an access network, or a virtualized network, to address some of the limitations as discussed above. For example, to address the issue where controlling an aerial drone is limited by the range of the radio signal, the present disclosure employs a communications network, e.g., a communications network having a radio access network such as a cellular network or a wireless network. In other words, in one example the aerial drone can be configured similar to a cellular phone or smart phone with the capability to interact with an access node, e.g., a cellular tower, of a cellular network. Thus, communications to and from the aerial drone can be continually maintained over a very large geographical area where coverage is provided by the communications network.

To address the need to meet stringent flight regulations, the present disclosure again leverages the use of the communications network, where policy driven control rules can be obtained from a plurality of entities, e.g., various federal or local government agencies or utilities, having jurisdiction over the use of an airspace in a particular locality. For example, the Federal Aviation Administration (FAA) may have a set of flight regulations pertaining to the use of various airspaces throughout the country, e.g., pertaining to restricted airspaces where no flying vehicles are allowed including aerial drones, pertaining to a minimum or maximum altitude that a flying vehicle is allowed to operate in for certain airspaces, pertaining to flight paths to be used in certain airspaces, and the like. In addition to federal agencies, state agencies may also exercise rights over airspaces that are not regulated by the FAA. For example, a state may prohibit any flight paths to be taken over the governor's mansion or over the state legislature buildings due to security concerns. In another example, a city within the state may also have its own local ordinances that regulate how airspaces are to be used within the city's airspace. Similarly, a local utility authority, e.g., a power utility such as a nuclear power plant, a drinking water treatment plant, a transportation authority for a bridge, a tunnel, a train depot, an airport, a bus depot, a ferry station and the like, may also have their own local regulations that prohibit, restrict or limit airspace usage above or near the utilities. In one embodiment, the communications network employs a dedicated application server, e.g., a database server, to interact with these entities for receiving and maintaining these stringent flight regulations, which are then translated into policy driven control rules to be uploaded to and used by the aerial drone as it traverses from one locality to another locality. In this manner, the aerial drone is able to receive a set of pertinent policy driven control rules that will be appropriate for governing its flight path.

In one example, the present disclosure again leverages the use of the communications network, where a flight path and the policy driven control rules can be provided directly to the aerial drone so that human control of the aerial drone can be eliminated or significantly minimized. In other words, once the aerial drone provides a starting coordinate and an ending coordinate to the communications network, the dedicated application server will compute a flight path for the aerial drone taking into account the set of pertinent policy driven control rules. For example, the flight path will define the route in which the aerial drone will take to arrive at the ending coordinate. It should be noted that the flight path itself may not be a single straight path, e.g., the flight path may comprise a route having a sequence of straight paths. In fact each of the straight paths may be at a different elevation within a volumetric space in response to the policy driven control rules. For example, the first segment of the route may dictate that the aerial drone be operated at 500 feet from point A to point B due to a first policy driven control rule, whereas the aerial drone will be operated at 1,000 feet from point B to point C due to a second policy driven control rule, and whereas the aerial drone will then be operated at 1,500 feet from point C to point D due to a third policy driven control rule, and so on. In this illustrative example, the first policy driven control rule may be implemented in response to a federal regulation put forth by the FAA, whereas the second policy driven control rule may be implemented in response to a state regulation, and finally whereas the third policy driven control rule may be implemented in response to a city regulation. In sum, the aerial drone's ability to address such disparate set of flight regulations is rooted in the present method of leveraging the use of a communications network that interacts with a plurality of entities that have authority over various airspaces traversed by the aerial drone.

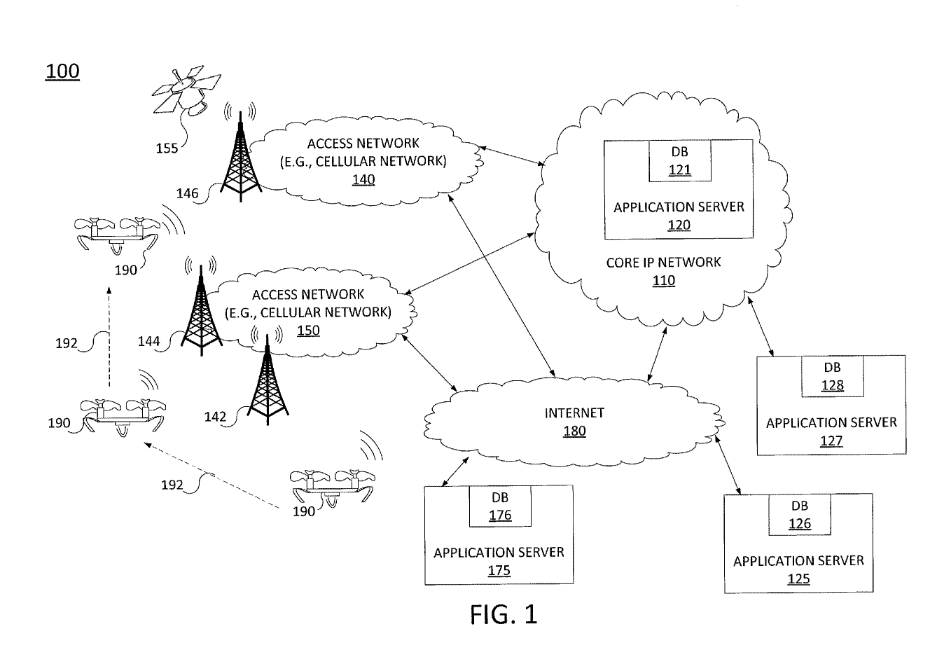

In one embodiment, the flight path and/or the set of policy driven control rules can be uploaded into a navigation unit of the aerial drone. For example, the navigation unit of the aerial drone may comprise an autopilot system and a global positioning system that are capable of applying the flight path and/or the set of policy driven control rules. Autopilot systems and global positioning systems are available from various companies and organizations such as Openpilot™, ArduPilot™ and the like that can be configured to employ the methods as discussed herein. However, the present disclosure is not limited by any particular type of autopilot systems and global positioning systems that will be deployed on the aerial drone. More specifically, the present disclosure provides an advancement in the collection and distribution of the flight path and/or the set of policy driven control rules via a communications network. These and other aspects of the present disclosure are discussed below in connection with the examples of FIGS. 1-6.

To aid in understanding the present disclosure, FIG. 1 illustrates an example system 100 for controlling an aerial drone through policy driven control rules via a network, e.g., a communications network, an access network, or a virtualized network. Although the present disclosure is discussed below in the context of a particular system or network architecture, the present disclosure is not so limited. Namely, the present disclosure can be applied to any type of communications network that is capable of transmitting data, such as a wireless local area network (WLAN), an Internet Protocol (IP) network, such as an Internet Protocol/Multi-Protocol Label Switching (IP/MPLS) core network, an IP Multimedia Subsystem (IMS) network, a virtualized network, communications over the Internet in general, and so forth.

As shown in FIG. 1, the system or network 100 may connect one or more aerial devices 190, e.g., aerial drones, with one or more servers via a core network, e.g., an Internet Protocol (IP) network 110, one or more access networks, e.g., cellular access networks 140 or 150, and/or Internet 180. In one example, access network 140 or 150 may comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA2000 network, among others. In other words, cellular access network 140 may comprise an access network in accordance with any “second generation” (2G), “third generation” (3G), “fourth generation” (4G), Long Term Evolution (LTE) or any other yet to be developed future wireless/cellular network technology. While the present disclosure is not limited to any particular type of cellular access network, in the illustrative example, cellular access network 140 is shown as a UMTS terrestrial radio access network (UTRAN) subsystem. Thus, network elements 142, 144 and 146 may comprise a Node B or an evolved Node B (eNodeB).

In one example, core IP network 110 comprises a telecommunication network service provider network with network devices or elements (not shown) which are capable of routing and forwarding IP packets between different hosts over the network. However, in one example, the components of core IP network 110 may have additional functions, e.g., for functioning as a public land mobile network (PLMN)-General Packet Radio Service (GPRS) core network, for providing Voice over Internet Protocol (VoIP), Service over Internet Protocol (SoIP), and so forth, and/or may utilize various different technologies, e.g., Asynchronous Transfer Mode (ATM), Frame Relay, multi-protocol label switching (MPLS), and so forth. In another example, the core IP network 110 may comprise an Evolved Packet Core (EPC) which provides the core network connectivity for LTE connecting the LTE network to the Internet via a PDN Gateway (packet data network gateway) and so on. Thus, it should be noted that although core IP network 110 is described as an Internet Protocol network, this does not imply that the functions are limited to IP functions, or that the functions are limited to any particular network layer.

In one example, aerial devices 190, e.g., aerial drones, may each comprise various mobile endpoint device components configured for wireless communication, e.g., components as used in a cellular phone or smart phone. In one example, aerial devices 190 may have both cellular and non-cellular access capabilities (e.g., satellite communication capabilities or wireless fidelity (WiFi) capabilities). In one example, each of aerial devices 190 may also be configured with an optical camera or video camera to capture images to assist in performing navigation operations or functions.

In one example, each of aerial devices 190 may also be capable of determining a location. For instance, any one or more of aerial devices 190 may be equipped with a global positioning system (GPS) component, or may be configured to determine a location via triangulation or other technique using measured distances between the aerial device 190 and one or more access points or base stations. In one example, each of the aerial devices 190 may calculate a device location directly, via local measurements on the device, or may receive location information from a centralized system component, e.g., an application server, as described below.

In accordance with the present disclosure, the aerial devices 190 may each run an application, or “local application,” which enables each aerial device 190 to interact with an application server (AS) (e.g., any one or more of AS 120 and AS 125) for bring about the controlling of the aerial device through policy driven control rules via a network, e.g., a communications network, an access network, or a virtualized network. In particular, in one example, the local application provides each aerial device 190 with the ability to interact with the AS 120 or AS 125 to receive a flight path and/or a set of policy driven control rules. The flight path and/or the set of policy driven control rules allow each aerial device 190 to travel from an origin location to a destination location and vice versa. The local application may also provide each aerial device 190 with the ability to provide location information of the aerial device 190 to the application server, and/or to receive location information of the aerial device 190 from the application server, and so forth.

In one example, the telecommunication network service provider may maintain an application server (AS) 120 in the core IP network 110 for providing aerial device controlling services, such as: receiving a request to control an aerial device, providing a flight path to the aerial device, providing a set of policy driven control rules to the aerial device, monitoring the aerial device traversing the flight path, detecting a modification or a new policy driven control rule that will impact the flight path of the aerial device, and providing dynamically the modification and/or the new policy driven control rule to the aerial device while the aerial device is in flight.

In turn, the network service provider (e.g., the owner and/or operator of core IP network 110) may maintain the AS 120 and a database (DB) 121 for storing the flight path information and a comprehensive set of policy driven control rules. For example, the flight path information and the comprehensive set of policy driven control rules may have been received from an AS 127 and a database (DB) 128 operated by one or more entities having authority over various airspaces. For example, a federal government agency, a local governmental agency and/or a utility may own and operate the AS 127 and DB 128. Thus, these entities may dynamically update their respective set of policies governing usage of the pertinent airspaces. For example, the FAA may dynamically put forth a restriction over a particular airspace due to a changing weather condition, e.g., a hurricane, a natural disaster, e.g., a volcano eruption, or an updated national security alert, e.g., an elevated homeland security alert, and so on. In turn, the AS 127 may automatically push forth (e.g., via an Really Simple Syndication (RSS) feed) any such new or modified set of policies governing usage of the pertinent airspaces to the AS 120 which will store these new or modified set of policies governing usage of the pertinent airspaces to DB 121.

In one alternate example, the operator of the aerial drone 190 may also own and operate the AS 175 and DB 176. Namely, the AS 175 may actually interact with AS 120 and DB 121 on behalf of the aerial device 190. In other words, the AS 175 may obtain the flight path and/or the set of policy driven control rules from the AS 120 and then upload the received flight path and/or the set of policy driven control rules to the aerial device 190.

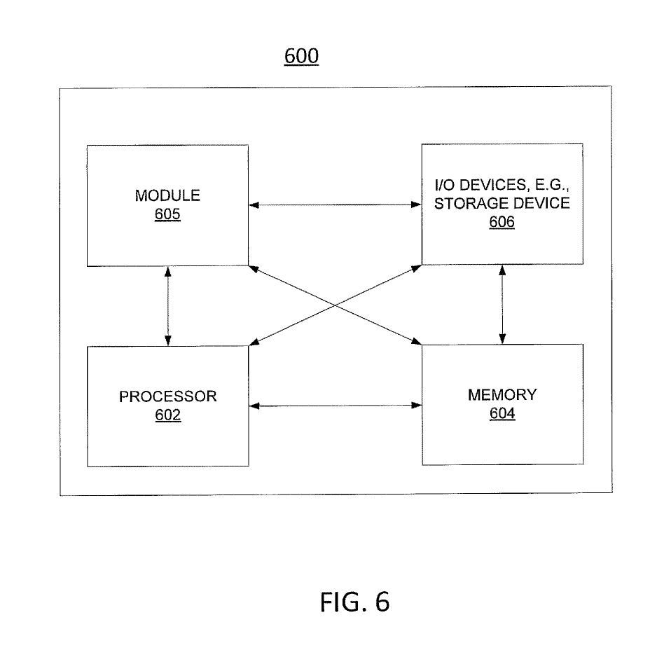

In one example, AS 120 may comprise a hardware server or computer such as illustrated and described in connection with FIG. 6, and the database 121 may be any type of electronic collection of data stored on a computer-readable medium, e.g., a hardware storage device. In addition, although AS 120 is illustrated as a single device, in one example, AS 120 may comprise a plurality of physical devices co-located or distributed in several physical locations, e.g., connected through a virtual private network (VPN), a permanent virtual circuit (PVC) (in the case where core IP network 110 may also include non-IP aspects), and the like.

In still another example, an application server, e.g., AS 125, may be maintained “in the cloud,” i.e., reachable via the Internet 180 in general. In one example, AS 125 is maintained by a network service provider, or is maintained by another entity, e.g., a cloud service provider. Similarly, AS 125 and AS 127 may comprise a hardware server or computer such as illustrated and described in connection with FIG. 6, and the DB 126 and DB 128 may be any type of electronic collection of data stored on a computer-readable medium, e.g., a hardware storage device. Accordingly, AS 125 may provide the same or substantially similar functions as 120, as described herein. Like AS 120, AS 125 may also comprise a plurality of servers co-located or distributed in several physical locations. In addition, it should be noted that the system 100 may be implemented in a different form than that illustrated in FIG. 1, or may be expanded by including additional aerial devices, access networks, network elements, application servers, etc. without altering the scope of the present disclosure.

In one embodiment, the core network 110 may be implemented as a software defined network (SDN) or a virtualized network. It is noted that SDN architectures decouple network control and forwarding functions, enabling network control to become directly programmable and the underlying infrastructure to be abstracted from applications and network services. As such, the SDN architecture enables the network to dynamically respond to application requirements. In one embodiment of the present disclosure, the AS 120 and DB 121 can be dynamically instantiated as necessary to support the controlling of an aerial device 190. In other words, as the aerial device 190 traverses across a large geographical area, e.g., from New York to New Jersey, a new and more geographically closer AS 120 and DB 121 can be dynamically instantiated to support the flight of the aerial device as it travels from a first location to a second location. Such dynamic instantiation will minimize latency.

For example, the aerial drone 190 traveling along flight path 192 may initially interact with a first network element, e.g., base station 142, and may subsequently be passed off to a second network element, e.g., base station 144, and then yet to a third network element, e.g., base station 146 and so on. Although AS 120 and DB 121 are illustrated as residing in the core network 110, their instantiation can be dynamically implemented in the access networks 140 or 150 or in a different geographical location within the core network 110 that is geographically closer to the aerial drone as the aerial drone traverses on its flight path. FIG. 1 also shows a satellite 155 to indicate that the aerial drone 190 may have non-cellular communication capability as well. The non-cellular communication capability can be used in certain geographical areas where cellular coverage is lacking or may simply serve as a backup or redundant communication capability.

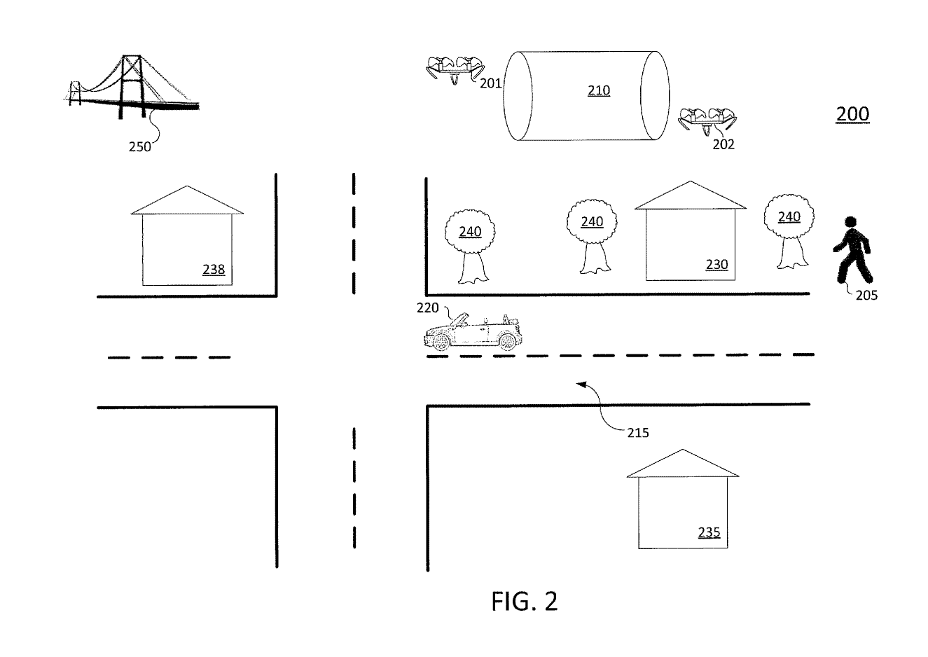

FIG. 2 illustrates an example environment 200 for illustrating how the aerial drones may be controlled to travel over a physical environment. For instance, the environment 200 may comprise a plurality of man-made fixed structures 230, 235, and 238, e.g., homes and a plurality of natural objects 240, e.g., trees. The environment 200 may also comprise a plurality of moving entities, e.g., a vehicle 220 on a road 215 and a human 205. The environment 200 may also illustrate a plurality of aerial drones 201 and 202 traversing above the man-made fixed structures 230, 235, and 238, and the moving entities 205 and 220. In this example, the aerial drones 201 and 202 are controlled to limit their travel within a predefined volumetric space 210 that is predefined in accordance with the set of policy driven control rules, where the predefined volumetric space 210 is intended to be above the man-made fixed structures and the plurality of natural objects. However, the environment 200 also illustrates certain restricted structures, e.g., a bridge 250, in which the aerial drones 201 and 202 are to avoid. In one embodiment, the flight path provided to the aerial drones 201 and 202 would take into account to avoid such restricted structures.

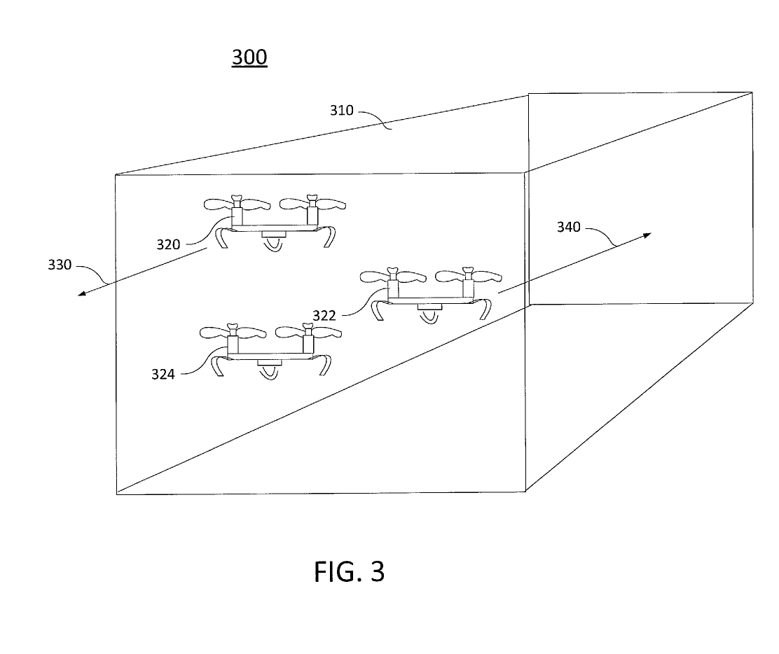

Continuing with the same example, FIG. 3 illustrates an environment 300 that includes a predefined volumetric space 310 and a plurality of aerial devices 320, 322, and 324. In this example, the predefined volumetric space 310 defines a volume of space that is specifically reserved for use by the plurality of aerial devices 320, 322, and 324. For example, the flight path 340 selected for aerial devices 322, and 324 is in the opposite direction from the flight path 330 selected for aerial device 320. It is noted that both flight paths 330 and 340 are within the predefined volumetric space 310. In one embodiment, the flight paths 330 and 340 are spatially offset from each other, e.g., in terms of elevation. For example, aerial drones traveling on flight path 340 could be flying at the altitude of 800 feet, whereas aerial drones traveling on flight path 330 could be flying at the altitude of 900 feet. Thus, aerial drones travelling in different directions are at different altitudes. It should be noted that more than one flight path can set in any direction. In one embodiment, each of the aerial drones is configured to maintain a safe distance (e.g., in all three: x, y, and z axes) from each other, e.g., a minimum of 50 feet, 75 feet, 100 feet and the like. Since the aerial drones are equipped to determine their geographical locations, maintaining such safe distance can be achieved automatically by the aerial drones using GPS coordinates or via the use of onboard image sensors. In another example, the aerial drones need not be assigned the same constraints in view of the policies. For example, aerial drones operating in a restricted area may be assigned slightly different longitude, latitude and/or altitude parameters, while still meeting the overall policies pertinent to the restricted area. For example, each of the aerial drones can be assigned a different altitude (e.g., 800 feet and 900 feet) while meeting the policies that restrict aerial drones to the altitude of 500-1000 feet. In another example, each of the aerial drones can be assigned the same altitude (e.g., 800 feet), but each drone is assigned to one of a plurality of different lanes having different longitude and/or latitude, while still meeting the policies pertinent to the restricted area.

Furthermore, although the present disclosure relates to unmanned aerial vehicles, the present disclosure is not so limited. In one illustrative example, the present disclosure can be applied to unmanned marine vehicles, e.g., unmanned vehicles that traverse via a water environment. Similar to a flight path, a water based route (e.g., a plotted course) may have high degrees of freedom. For example, an unmanned marine vehicle may travel on top of and/or below a water surface line, e.g., the unmanned marine vehicle may be operated under the water surface of a body of water, e.g., a lake, a river, a sea and/or an ocean.

It should be noted that the examples of FIGS. 2 and 3 are provided for illustrative purposes. In addition, a variety of different types of aerial devices in a different form than that illustrated in FIGS. 2 and 3 may be utilized without altering the scope of the present disclosure. It should also be noted that in various examples, the aerial devices of FIGS. 2 and 3 may be interacting with one or more servers for receiving and/or reporting location information, for receiving a modified flight path, and for receiving a modified or new policy driven control rule, and so forth.

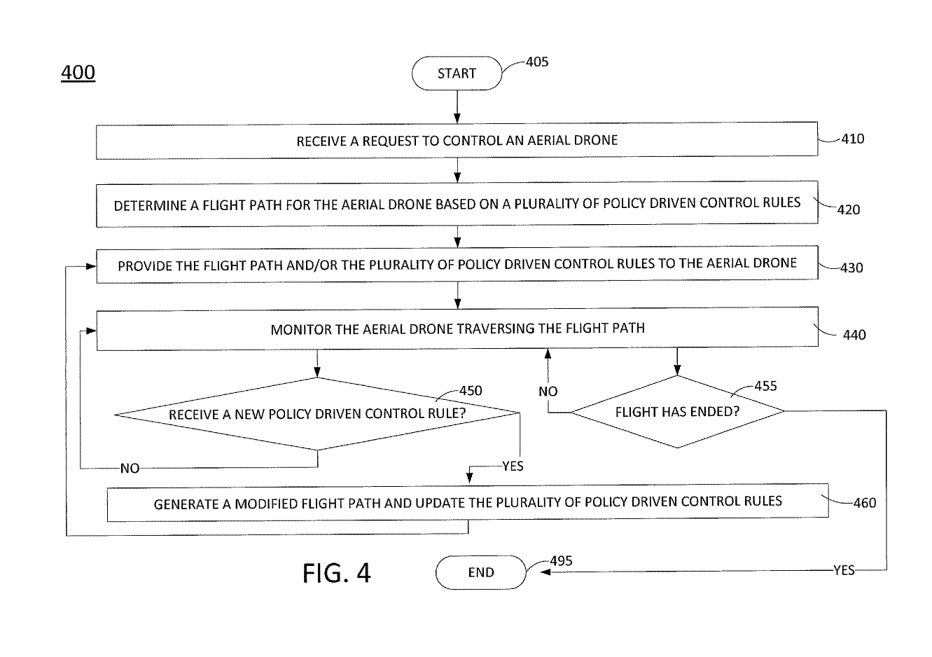

FIG. 4 illustrates a flowchart of an example method 400 for controlling an aerial drone through policy driven control rules via a network according to the present disclosure. In one example, the steps, operations, or functions of the method 400 may be performed by AS 120 or AS 125 of FIG. 1, e.g., a dedicated database server. Alternatively, one or more steps, operations, or functions of the method 400 may be implemented by a computing device having a processor, a memory, and input/output devices as illustrated in FIG. 6 and described below, specifically programmed to perform the steps, functions, and/or operations of the method. For illustrative purposes, the method 400 will now be described in terms of an example where operations of the method are performed by a processor, such as processor 602 of FIG. 6.

The method 400 begins in step 405 and proceeds to step 410. In step 410, the processor receives a request to control an aerial drone. For example, the aerial drone may send a request that is received by the AS 120, where the request may include an origin location and a destination location. It should be noted that the location information can be represented in GPS coordinates, street addresses, and the like. Alternatively, the request may not have originated from the aerial drone itself, but instead, may have originated from an AS of the operator of the aerial drone. For example, a shipping company may have originated the request. Once the flight path and/or the set of policy driven control rules are received by the shipping company, an operator of the shipping company can forward the received flight path and/or the set of policy driven control rules onto the aerial drone. In one embodiment, the format of the flight path can be implemented in a number of different ways. For example, the flight path may comprise a series of segments or flight durations where parameters such as longitude, latitude, altitude, speed, acceleration and/or heading are defined for each segment. Alternatively, in another example, the flight path may be implemented with less complexity where the flight path merely comprises a plurality of headings and altitude limits for a plurality of segments of the flight path. The set of policy driven control rules can then be applied to this less complex flight path. As such, the format of the flight path can be implemented in a number of different way and should not be viewed as a limitation in the scope of the present disclosure.

At step 420, the processor determines a flight path and/or the set of policy driven control rules using the origin location (e.g., the current location of the aerial drone) and the destination location information received in step 410. For example, the method calculates the most direct route between the origin location and the destination location, while taking into consideration the set of policy driven control rules that are pertinent to the calculated route. Once the parameters of the pertinent set of policy driven control rules are applied to the calculated route, then a flight path is generated. In other words, in one example the flight path already contains the various restrictions and/or guidelines that are set forth in the pertinent set of policy driven control rules.

At step 430, the processor provides the flight path and/or the pertinent set of policy driven control rules in response to the request. For example, if the request originated from the aerial drone, then the flight path and/or the pertinent set of policy driven control rules will be sent directly to the aerial drone. However, if the request originated from the AS 175 of the operator of the aerial drone, then the flight path and/or the pertinent set of policy driven control rules will be sent directly to the AS 175 of the operator of the aerial drone. Alternatively, if the AS 175 of the operator of the aerial drone determines that a constraint needs to be satisfied, then the AS 175 of the operator of the aerial drone may determine how meeting the constraint will change the flight path, and it is the constrained flight path that is sent to the aerial drone. It should be noted that in one embodiment, only the policy constrained flight path is sent back in response to the request. In other words, the flight path already contains the various restrictions and/or guidelines that are set forth in the pertinent set of policy driven control rules, e.g., the maximum and minimum altitude, the maximum and minimum speed, the maximum and minimum separation between aerial drones, the time and date in which the flight path can be used, the maximum and minimum load (e.g., by weight or shape) that can be carried by the aerial drone, the type of goods that can be carried and delivered on this flight path, and so on. In one example, the set of policy driven control rules will not be provided to the aerial drone or the operator of the aerial drone due to the fact that content of the set of policy driven control rules may be proprietary or is sensitive security information that should not be distributed. Alternatively, the set of policy driven control rules can be provided to the aerial drone, which will only apply the set of policy driven control rules for navigation, but will not be able to disclose the set of policy driven control rules external to the aerial drone.

In one embodiment, providing the flight path may further comprise an “enforcement” function. For example, the network service provider may examine all control commands from a “live” human operator forwarded to the aerial drone, as the control commands must pass through the communications network of the network service provider. The automated system of the network service provider may filter the control commands. For instance, if the human operator or remote autopilot directs the aerial drone to turn left or right, to increase altitude, to decrease altitude, to increase airspeed, or to decrease airspeed outside of the allowed parameters of the airspace, the network can filter the control commands, pass other control commands to the aerial drone, and/or insert new control commands. For example, if the aerial drone is traveling at 700 feet and is about to enter a 1000 feet minimum zone, the network can directly instruct the aerial drone to change altitude to 1000 feet, even if the aerial drone is currently being operated by a human operator. In one example, the change in altitude is preceded with a warning (visual or audio) informing the human operator of the impending change in altitude due to a local policy and so on.

In one embodiment, the communications exchanged in steps 410 and 430 are encrypted. In other words, an encryption method is agreed upon between the communicating parties (e.g., using a set of public and private keys). It is necessary to protect such communications to protect the operations of the aerial drone. Namely, such communications can be protected from being intercepted and altered by malicious parties with malicious or mischievous intents, e.g., an intent to divert the aerial drone to steal the load carried by the aerial drone, an intent to divert the aerial drone to steal the aerial drone itself, an intent to highjack and operate the aerial drone in an unsafe manner, and so on.

At step 440, the processor monitors the aerial drone traversing the flight path. For example, similar to a mobile cellular phone being passed along between various cell towers, the AS 120 is able to determine the progress of the aerial drone based on its communication with various access points of the communications network.

At step 450, the processor determines whether a new or a modified policy driven control rule is received. As discussed above, AS 120 is configured to dynamically receive any change or update as to policies governing airspace usage from a plurality of entities having such authority over airspace usage. If the query is negatively answered, then the processor returns to step 440 to continue the monitoring of the aerial drone traversing the flight path. If the query is positively answered, then the processor proceeds to step 460.

In step 460, the processor generates a modified flight path and/or a modified set of policy driven control rules based on the change or update as to policies governing airspace impacting the flight path of the aerial drone. In other words, only pertinent changes affecting the current flight path will be addressed. The method then returns to step 430 where the modified flight path and/or the modified set of policy driven control rules will be sent to the aerial drone or the operator of the aerial drone.

At step 455, the processor determines whether the flight has concluded, e.g., whether the aerial drone has arrived at the destination and/or has also returned to its origin location. If the query is negatively answered, then the processor returns to step 440 to continue the monitoring of the aerial drone traversing the flight path. If the query is positively answered, then the processor proceeds to step 495 where the method 400 ends.

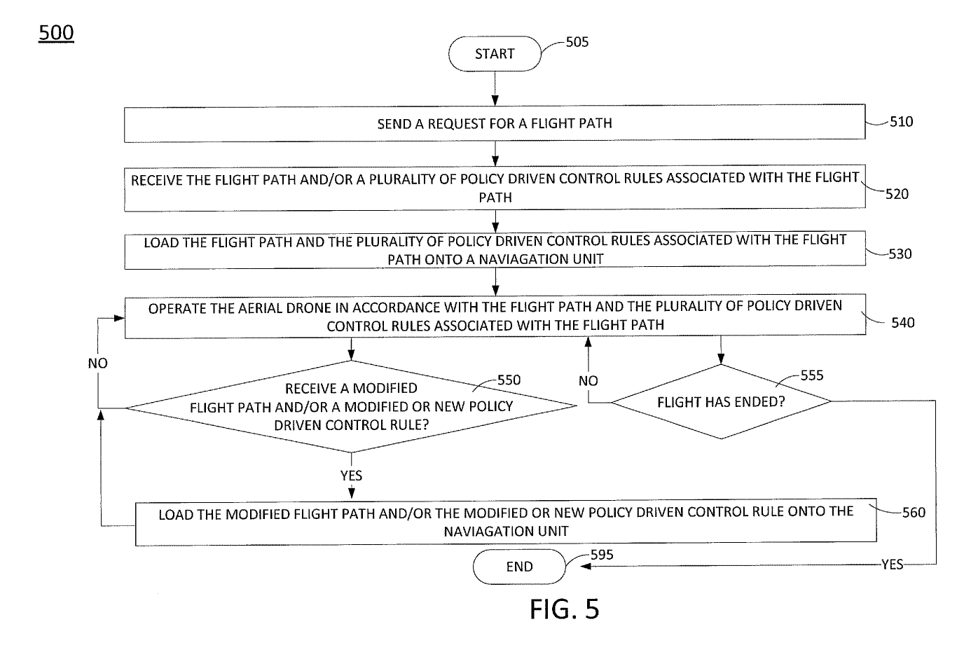

FIG. 5 illustrates a flowchart of an example method 500 for controlling an aerial drone through policy driven control rules via a network according to the present disclosure. In one example, the steps, operations, or functions of the method 500 may be performed by an AS operated by an operator of the aerial drone or by a processor or controller deployed within the aerial drone itself. Alternatively, one or more steps, operations, or functions of the method 500 may be implemented by a computing device having a processor, a memory, and input/output devices as illustrated in FIG. 6 and described below, specifically programmed to perform the steps, functions, and/or operations of the method. For illustrative purposes, the method 500 will now be described in terms of an example where operations of the method are performed by a processor, such as processor 602 of FIG. 6.

The method 500 begins in step 505 and proceeds to step 510. In step 510, the processor sends a request for a flight plan for an aerial drone. For example, the aerial drone may send a request to the AS 120, where the request may include an origin location and a destination location. It should be noted that the location information can be represented in GPS coordinates, street addresses, and the like. Alternatively, the request may not have originated from the aerial drone itself, but instead, may have originated from an AS of the operator of the aerial drone. For example, a shipping company may have originated the request. Once the flight path and/or the set of policy driven control rules are received by the shipping company, an operator of the shipping company can forward the received flight path and/or the set of policy driven control rules onto the aerial drone.

At step 520, the processor receives the flight path and/or the pertinent set of policy driven control rules in response to the request. For example, if the request originated from the aerial drone, then the flight path and/or the pertinent set of policy driven control rules will be received directly by the aerial drone. However, if the request originated from an AS of the operator of the aerial drone, then the flight path and/or the pertinent set of policy driven control rules will be received directly by the AS of the operator of the aerial drone. It should be noted that in one embodiment, only the flight path is received in response to the request.

In one embodiment, the communications exchanged in steps 510 and 520 are encrypted. In other words, an encryption method is agreed upon between the communicating parties.

At step 530, the processor loads the flight path and/or the pertinent set of policy driven control rules onto a navigation unit. In other words, the specific parameters of the flight path can be loaded onto an autopilot system of the aerial drone.

At step 540, the processor operates the aerial drone in accordance with the flight path and/or the pertinent set of policy driven control rules. In other words, the aerial drone is operated to take flight using the flight path and/or the pertinent set of policy driven control rules stored in the autopilot system of the aerial drone.

At step 550, the processor determines whether a new or a modified policy driven control rule is received. If the query is negatively answered, then the processor returns to step 540 to continue the operating of the aerial drone traversing the flight path. If the query is positively answered, then the processor proceeds to step 560.

In step 560, the processor loads the modified flight path and/or the modified set of policy driven control rules onto the navigation unit. In other words, the specific parameters of the modified flight path can be loaded onto the autopilot system of the aerial drone.

At step 555, the processor determines whether the flight has concluded, e.g., whether the aerial drone has arrived at the destination and/or has also returned to its origin location. If the query is negatively answered, then the processor returns to step 540 to continue the monitoring of the aerial drone traversing the flight path. If the query is positively answered, then the processor proceeds to step 595 where the method 500 ends.

As such, the present disclosure provides at least one advancement in the technical field of controlling aerial drones. Namely, the infrastructure of a communications network is utilized to control the movements of aerial drones.

In addition, although not specifically specified, one or more steps, functions or operations of the respective methods 400 and 500 may include a storing, displaying and/or outputting step as required for a particular application. In other words, any data, records, fields, and/or intermediate results discussed in the methods can be stored, displayed and/or outputted either on the device executing the methods 400 or 500, or to another device, as required for a particular application.

Furthermore, steps, blocks, functions or operations in FIGS. 4 and 5 that recite a determining operation or involve a decision do not necessarily require that both branches of the determining operation be practiced. In other words, one of the branches of the determining operation can be deemed as an optional step. Furthermore, steps, blocks, functions or operations of the above described methods can be combined, separated, and/or performed in a different order from that described above, without departing from the examples of the present disclosure.

FIG. 6 depicts a high-level block diagram of a computing device suitable for use in performing the functions described herein. As depicted in FIG. 6, the system 600 comprises one or more hardware processor elements 602 (e.g., a central processing unit (CPU), a microprocessor, or a multi-core processor), a memory 604 (e.g., random access memory (RAM) and/or read only memory (ROM)), a module 605 for controlling an aerial drone through policy driven control rules via a network, and various input/output devices 606 (e.g., storage devices, including but not limited to, a tape drive, a floppy drive, a hard disk drive or a compact disk drive, a receiver, a transmitter, a speaker, a display, a speech synthesizer, a GPS system, an autopilot system, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if any one or more of the methods 400 or 500 as discussed above is implemented in a distributed or parallel manner for a particular illustrative example, i.e., the steps of the method, or the entire method is implemented across multiple or parallel computing devices, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

The one or more hardware processors 602 can also be configured or programmed to cause other devices to perform one or more operations as discussed above. In other words, the one or more hardware processors 602 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method. In one example, instructions and data for the present module or process 605 for controlling an aerial drone through policy driven control rules via a network (e.g., a software program comprising computer-executable instructions) can be loaded into memory 604 and executed by hardware processor element 602 to implement the steps, functions or operations as discussed above in connection with the illustrative methods 400 and 500. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 605 for controlling an aerial drone through policy driven control rules via a network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

1. A method comprising:
receiving, by a processor of a communications network, a request for a flight path for an unmanned aerial vehicle, the request comprising an origin location and a destination location;
determining, by the processor, the flight path for the unmanned aerial vehicle based on the origin location and the destination location, wherein the flight path is determined based on at least one policy driven control rule, wherein the at least one policy driven control rule comprises a restriction on an airspace usage;
providing, by the processor, the flight path in response to the request; and
monitoring, by the processor, the unmanned aerial vehicle traversing the flight path.

2. The method of claim 1, wherein the flight path is provided directly to the unmanned aerial vehicle.

3. The method of claim 1, wherein the flight path is provided to an application server of an operator of the unmanned aerial vehicle.

4. The method of claim 1, wherein the at least one policy driven control rule is provided directly to the unmanned aerial vehicle.

5. The method of claim 1, wherein the at least one policy driven control rule is provided to an application server of an operator of the unmanned aerial vehicle.

6. The method of claim 1, further comprising:
receiving, by the processor, a new policy driven control rule;
generating, by the processor, a modified flight path based on the new policy driven control rule; and
providing, by the processor, the modified flight path in response to the receiving the new policy driven control rule.

7. The method of claim 6, wherein the modified flight path is provided directly to the unmanned aerial vehicle.

8. The method of claim 6, wherein the modified flight path is provided to an application server of an operator of the unmanned aerial vehicle.

9. The method of claim 6, wherein the new policy driven control rule is provided directly to the unmanned aerial vehicle.

10. The method of claim 6, wherein the new policy driven control rule is provided to an application server of an operator of the unmanned aerial vehicle.

11. The method of claim 1, wherein the communications network is a software defined network.

12. The method of claim 1, wherein the at least one policy driven control rule comprises a plurality of policy driven control rules, wherein the plurality of policy driven control rules is put forth by a plurality of government agencies having authority over airspaces.

13. A non-transitory computer-readable medium storing instructions which, when executed by a processor of a communications network, cause the processor to perform operations, the operations comprising:
receiving a request for a flight path for an unmanned aerial vehicle, the request comprising an origin location and a destination location;
determining the flight path for the unmanned aerial vehicle based on the origin location and the destination location, wherein the flight path is determined based on at least one policy driven control rule, wherein the at least one policy driven control rule comprises a restriction on an airspace usage;
providing the flight path in response to the request; and
monitoring the unmanned aerial vehicle traversing the flight path.

14. The non-transitory computer-readable medium of claim 13, wherein the flight path is provided directly to the unmanned aerial vehicle.

15. The non-transitory computer-readable medium of claim 13, wherein the flight path is provided to an application server of an operator of the unmanned aerial vehicle.

16. The non-transitory computer-readable medium of claim 13, wherein the at least one policy driven control rule is provided directly to the unmanned aerial vehicle.

17. The non-transitory computer-readable medium of claim 13, wherein the at least one policy driven control rule is provided to an application server of an operator of the unmanned aerial vehicle.

18. The non-transitory computer-readable medium of claim 13, further comprising:
receiving a new policy driven control rule;
generating a modified flight path based on the new policy driven control rule; and
providing, by the processor, the modified flight path in response to the receiving the new policy driven control rule.

19. The non-transitory computer-readable medium of claim 18, wherein the modified flight path is provided directly to the unmanned aerial vehicle.

20. An apparatus comprising:
a processor of a communications network; and
a computer-readable storage device storing a plurality of instructions which, when executed by the processor, cause the processor to perform operations, the operations comprising:
receiving a request for a flight path for an unmanned aerial vehicle, the request comprising an origin location and a destination location;
determining the flight path for the unmanned aerial vehicle based on the origin location and the destination location, wherein the flight path is determined based on at least one policy driven control rule, wherein the at least one policy driven control rule comprises a restriction on an airspace usage;
providing the flight path in response to the request; and
monitoring the unmanned aerial vehicle traversing the flight path.
